(19) United States
(12) Patent Application Publication
(10) Pub. No.: US 2002/0123939 A1
(43) Pub. Date: Sep. 5, 2002

(54) Method for establishing internet trading system

(76) Inventor: Chen Shi Yang, His Chin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/797,559

(22) Filed: Mar. 5, 2001

(51) Int. Cl. G06F 17/60

(52) U.S. Cl. 705/26

(57) ABSTRACT

An Internet trading method is provided to establish a Web site in a computer server. The Web site facilitates the owner thereof to deal commerce with any provider or any customer through Internet. The Internet trading system comprises a B2C (business to client) transaction item setting unit to set transaction items; a function setting unit, a template setting unit and a mail setting unit to facilitate the commerce.

### FIELD OF THE INVENTION

The present invention relates to a method for Internet trading, especially to a method for Internet trading to establish a web site in an integral way.

### BACKGROUND OF THE INVENTION

The e-commerce become more and more attractive as the Internet is popular over the world. Therefore, the set up and maintenance of Web site are important issues to ensure and facilitate the e-commerce for business such that the business can smoothly deal with provider and customers.

### SUMMARY OF THE INVENTION

It is the object of the present invention to provide a method for establishing Internet trading system, whereby the trade-related items can be easily set, the function category, function description, function code and function on/off can be easily set and modified, different template can be chosen and the mail server can be easily set.

To achieve above object, the present invention provides a method for Internet trading system to establish a Web site in a computer server. The Web site facilitates the owner thereof to deal commerce with any provider or any customer through Internet. The Internet trading system comprises a B2C (business to client) transaction item setting unit to set transaction items; a function setting unit, a template setting unit and a mail setting unit to facilitate the commerce.

The various objects and advantages of the present invention will be more readily understood from the following detailed description when read in conjunction with the appended drawing, in which:

### BRIEF DESCRIPTION OF DRAWING

FIG. 1 shows the schematic diagram of the present invention for dealing commerce in Internet;

FIG. 2 shows the functional block of the present invention;

FIGS. 3A, 3B and 3C show the flowchart for the operation of the B2C transaction item setting unit;

FIG. 4 shows the maintenance flowchart of the function setting unit of the trading system of the present invention;

FIG. 5 shows the maintenance flowchart of the template setting unit of the trading system of the present invention; and

FIG. 6 shows the maintenance flowchart of the mail setting unit of the trading system of the present invention.

### DETAILED DESCRIPTION OF THE INVENTION

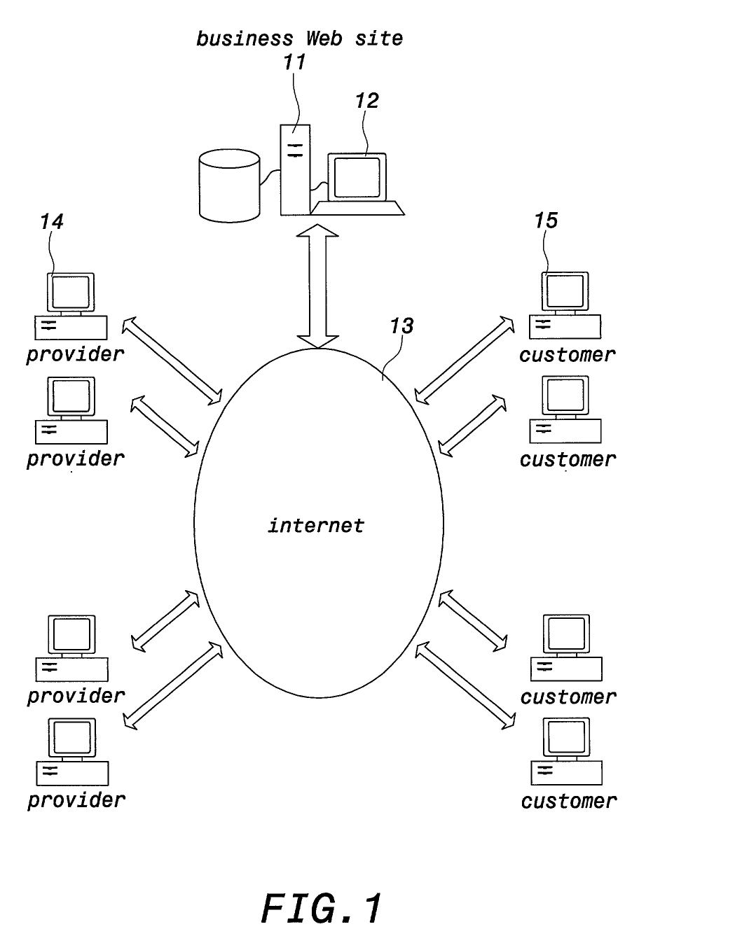

FIG. 1 shows the schematic diagram of the present invention for dealing commerce in Internet. The present invention provides a business Web site 12 in the computer server 11 of the company using the trading system of the present invention. The company using the trading system of the present invention can deal commerce with a provider 14 or a customer 15 through the Internet 13. Moreover, any provider 14 or customer 15 can also access the business Web site 12 through the Internet 13 for trading. The business Web site 12 according to the present invention can be established by the HTML, JAVA script, SQL and JSP and by the technologies of distributed structure, object-oriented skill and interactive user interface. The computer hardware used in the present invention comprises computer, modem, xDSL modem, cable modem, and leased line. The software used in the present invention includes web browser and e-mail software.

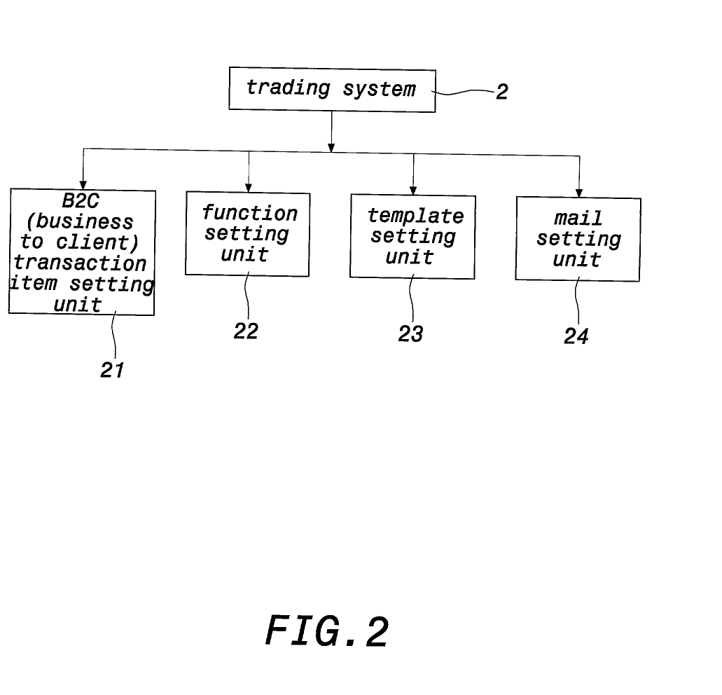

FIG. 2 shows the functional block of the present invention. The business Web site 12 is placed on the computer server 11 of the company using the trading system of the present invention. The business Web site 12 contains related data such as company profile, product information and a trading system 2 for trading over the Internet. The trading system 2 comprises a B2C (business to client) transaction item setting unit 21, a function setting unit 22, a template setting unit 23 and a mail setting unit 24 such that the function of the trading system can be easily set and modified by system programmer.

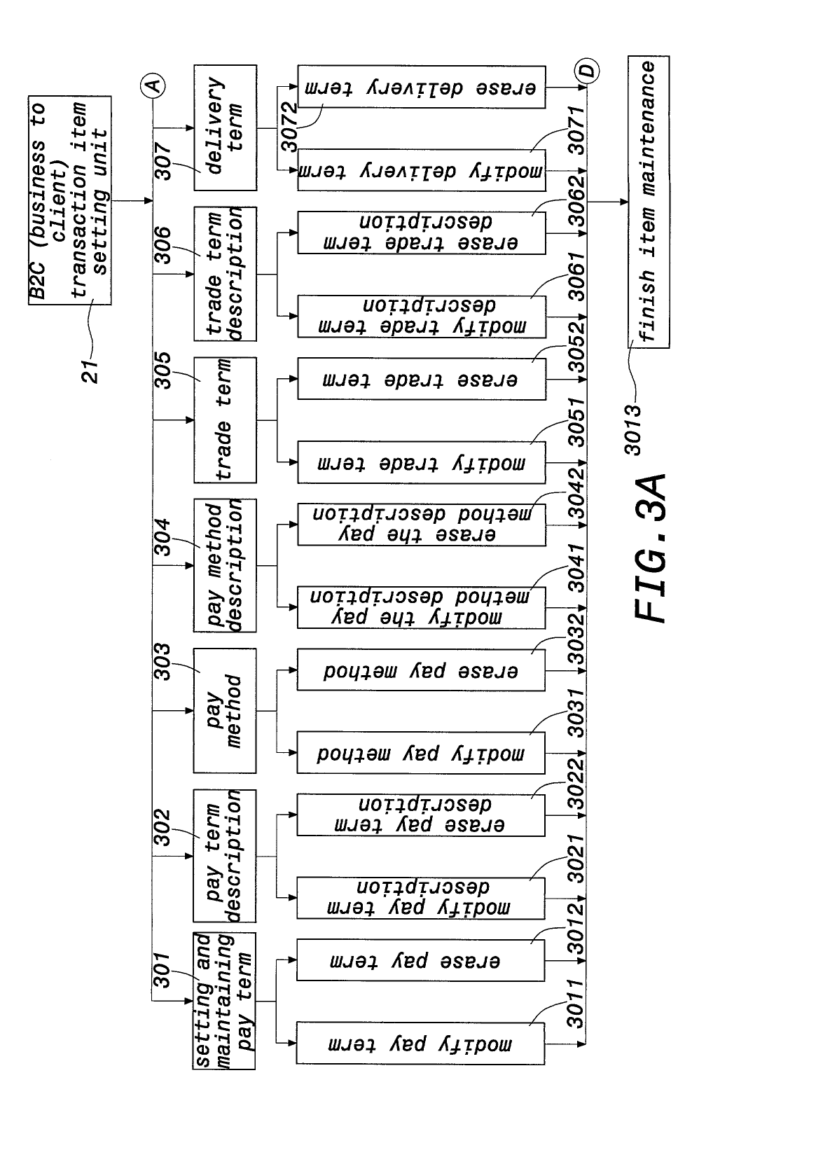

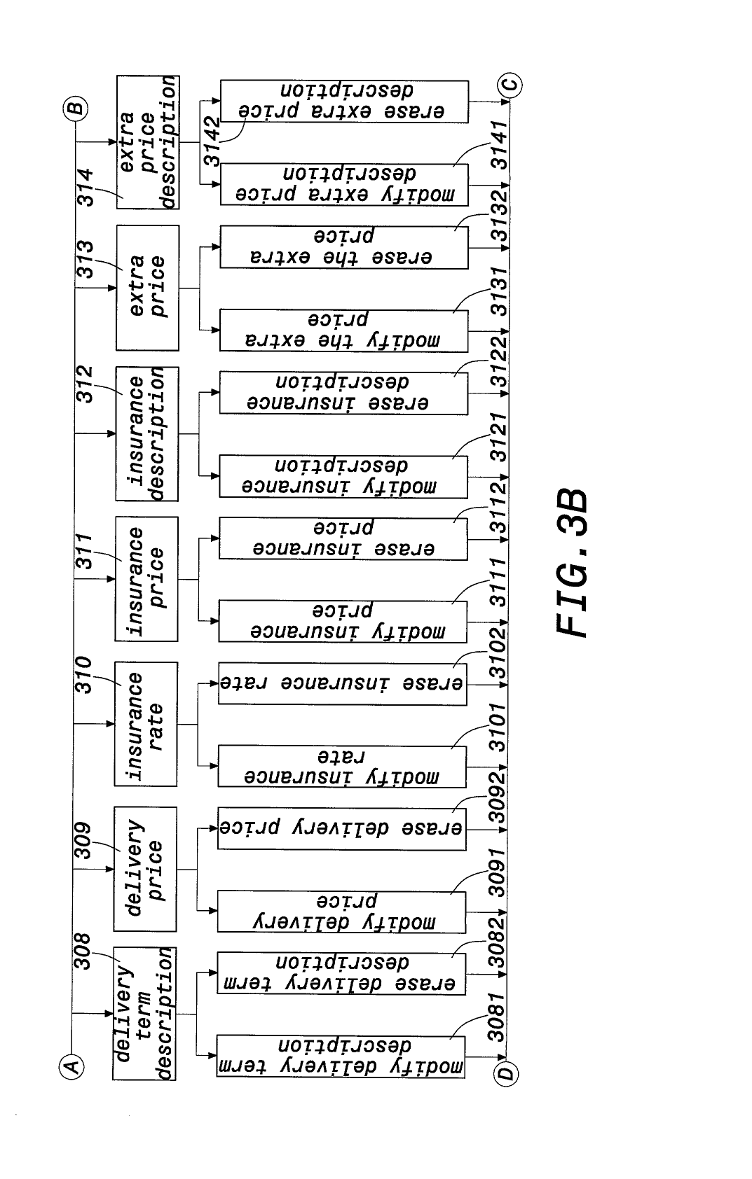

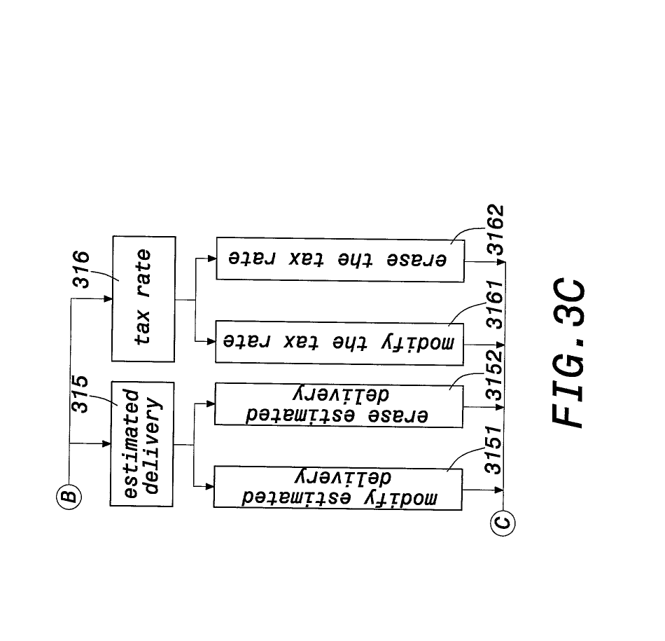

FIGS. 3A, 3B and 3C show the flowchart for the operation of the B2C transaction item setting unit. The flowchart comprises the following steps: item 301: setting and maintaining pay term; item 302 pay term description; item 303: pay method; item 304: pay method description; item 305: trade term; item 306: trade term description; item 307: delivery term; item 308: delivery term description; item 309: delivery price; item 310: insurance rate; item 311: insurance price; item 312: insurance description; item 313: extra price; item 314: extra price description; item 315: estimated delivery; item 316: tax rate.

When the item 301 of setting and maintaining pay term is chosen, the due date of payment is listed and the programmer can modify the pay term in step 3011 or erase the pay term in step 3012 to finish item maintenance in step 3013.

When the item 302 of pay term description is chosen, the pay term description is listed and the programmer can modify the pay term description in step 3021 or erase the pay term description in step 3022 to finish item maintenance in step 3013.

When the item 303 of pay method is chosen, the pay method such as credit card or cash is listed and the programmer can modify the pay method in step 3031 or erase the pay method in step 3032 to finish item maintenance in step 3013.

When the item 304 of pay method description is chosen, the pay method description is listed and the programmer can modify the pay method description in step 3041 or erase the pay method description in step 3042 to finish item maintenance in step 3013.

When the item 305 of trade term is chosen, the trade term such as common transaction, bidding, buying or selling is listed; and the programmer can modify the trade term in step 3051 or erase the trade term in step 3052 to finish item maintenance in step 3013.

When the item 306 of trade term description is chosen, the trade term description is listed; and the programmer can modify the trade term description in step 3061 or erase the trade term description in step 3062 to finish item maintenance in step 3013.

When the item 307 of delivery term is chosen, the delivery term such as mailing or express delivery is listed; and the programmer can modify the delivery term in step 3071 or erase the delivery term in step 3072 to finish item maintenance in step 3013.

When the item 308 of delivery term description is chosen, the delivery term description is listed; and the programmer can modify the delivery term description in step 3081 or erase the delivery term description in step 3082 to finish item maintenance in step 3013.

When the item 309 of delivery price is chosen, the delivery price is listed; and the programmer can modify the delivery price in step 3091 or erase the delivery price in step 3092 to finish item maintenance in step 3013.

When the item 310 of insurance rate is chosen, the insurance rate for the transaction is listed; and the programmer can modify the insurance rate in step 3101 or erase the insurance rate in step 3102 to finish item maintenance in step 3013.

When the item 311 of insurance price is chosen, the insurance price for the transaction is listed; and the programmer can modify the insurance price in step 3111 or erase the insurance price in step 3112 to finish item maintenance in step 3013.

When the item 312 of insurance description is chosen, the insurance description for the transaction is listed; and the programmer can modify the insurance description in step 3121 or erase the insurance description in step 3122 to finish item maintenance in step 3013.

When the item 313 of extra price is chosen, the extra price for the transaction is listed; and the programmer can modify the extra price in step 3131 or erase the extra price in step 3132 to finish item maintenance in step 3013.

When the item 314 of extra price description is chosen, the extra price description for the transaction is listed; and the programmer can modify the extra price description in step 3141 or erase the extra price description in step 3142 to finish item maintenance in step 3013.

When the item 315 of estimated delivery is chosen, the date of estimated delivery for the transaction is listed; and the programmer can modify the estimated delivery in step 3151 or erase the estimated delivery in step 3152 to finish item maintenance in step 3013.

When the item 316 of tax rate is chosen, the tax rate for the transaction is listed; and the programmer can modify the tax rate in step 3161 or erase the tax rate in step 3162 to finish item maintenance in step 3013.

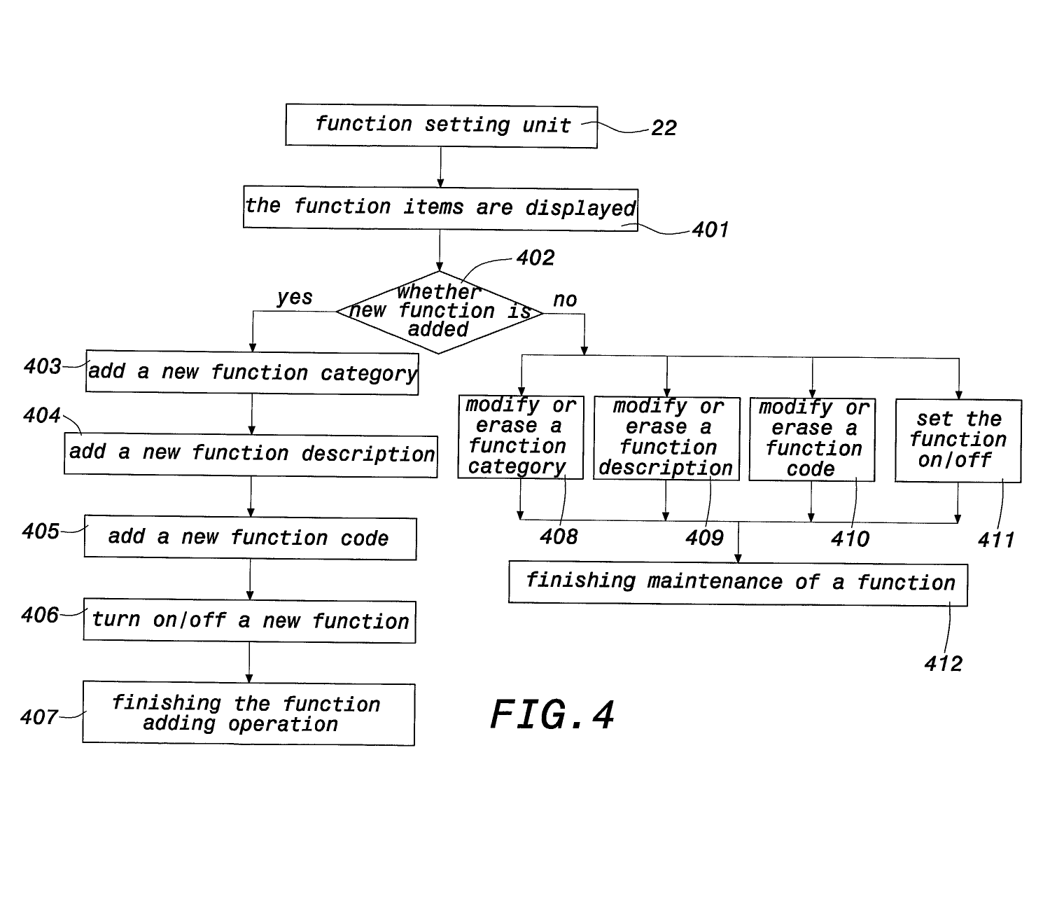

FIG. 4 shows the maintenance flowchart of the function setting unit 22 of the trading system of the present invention. When the item for the function setting unit is chosen, the function items are displayed in step 401. In step 402, the user is asked whether new function is added.

If new function is to be added, the programmer add a new function category in step 403, add a new function description in step 404; add a new function code in step 405 and turn on/off this new function in step 406, thus finishing the function adding in step 407.

If new function is not to be added, the programmer can choose to modify or erase a function category in step 408; or to modify or erase a function description in step 409; or to modify or erase a function code in step 410; or to set the function on/off in step 411, thus finishing maintenance of a function in step 412.

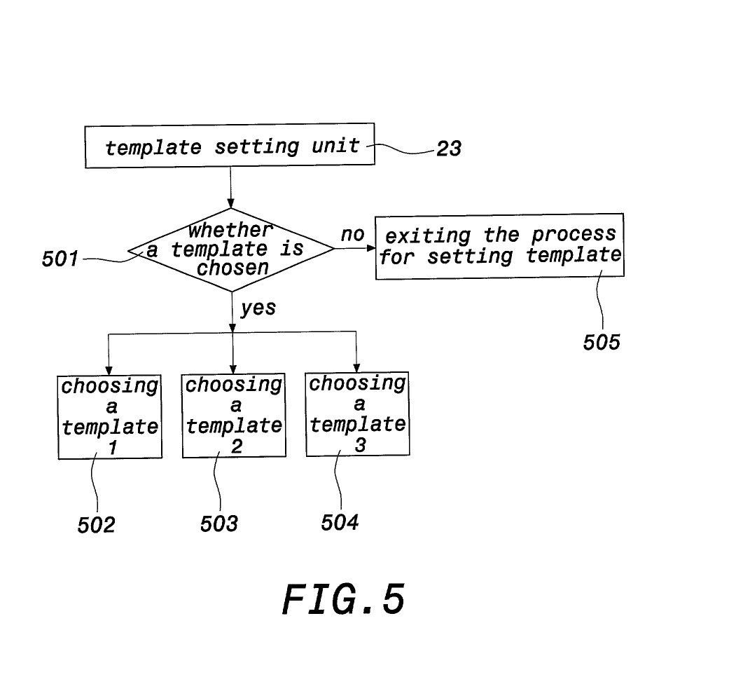

FIG. 5 shows the maintenance flowchart of the template setting unit 23 of the trading system of the present invention. When the item for the template setting unit is chosen, the user is asked whether a template is chosen in step 501.

If a template is to be chosen, the programmer chooses a template 1 in step 502, or a template 2 in step 503, or a template 3 in step 504, thus updating the template for the Web page. If a template is not to be chosen, the process for setting template is exited in step 505.

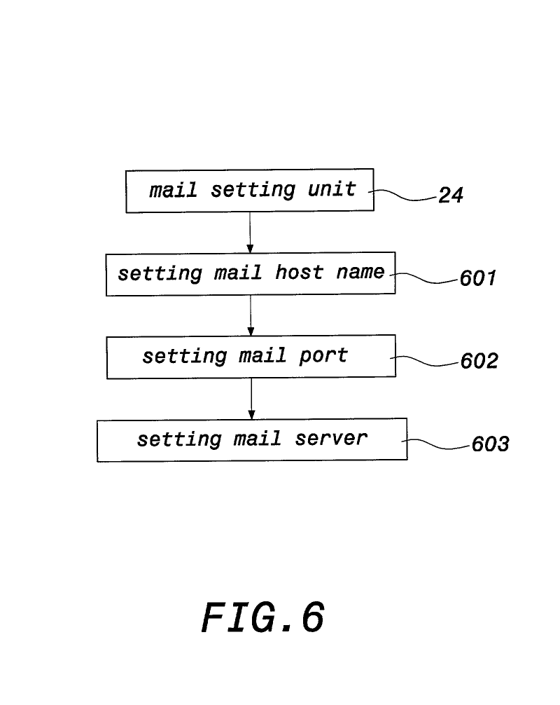

FIG. 6 shows the maintenance flowchart of the mail setting unit 24 of the trading system of the present invention. When the item for the mail setting unit is chosen, the programmer can set mail host name in step 601, set the mail port in step 602, set the mail server in step 603, thus finishing the mail setting.

As can be seen from above description, the Internet trading system of the present invention can be easily set, modified and erased according to user's need, thus ensuring and facilitating the e-commerce for business

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

I claim:

1. A method for establishing Internet trading system by setting a Web site in a computer server, the Web site facilitating the owner thereof to deal commerce with provider or customer through Internet; the Internet trading method comprising the steps of:
establishing a B2C (business to client) transaction item setting unit to set transaction items;
establishing a function setting unit to establish function category, function description, function code and to turn on/off a function;
establishing a template setting unit to choose a template for the Web site; and
establishing a mail setting unit to set up a mail server for the Web site and provide mail service.

2. The method for establishing Internet trading system as in claim 1, wherein the B2C (business to client) transaction item setting unit set following transaction items: pay term; pay term description; pay method; pay method description; trade term; trade term description; delivery term; delivery term description; delivery price; insurance rate; insurance price; insurance description; extra price; extra price description; estimated delivery; and tax rate.

3. The method for establishing Internet trading system as in claim 1, wherein the function setting unit is maintained by following steps:
(a) The function list is displayed;
(b) If a new function is to be added, a new function category, a new function description, a new function code and a new function on/off are added to add a new function, or
(c) The function category, function description, function code and function on/off are modified or erased to maintain a function.

4. The method for establishing Internet trading system as in claim 1, wherein the template setting unit is maintained by following steps:
(a) If a template is to be chosen, a template is chosen from a template list; or
(b) exiting from the template list.

5. The method for establishing Internet trading system as in claim 1, wherein the mail setting unit is maintained by following steps:
(a) setting host name;
(b) setting mail port; and
(c) setting mail server.
